(19) United States
(12) Patent Application Publication
(10) Pub. No.: US 2009/0327148 A1
(43) Pub. Date: Dec. 31, 2009

(54) MECHANISMS AND ARCHITECTURE FOR MOBILE OPPORTUNISTIC COMMERCE

(75) Inventors: Semiha Ece Kamar, Cambridge, MA (US); Eric Horvitz, Kirkland, WA (US); Christopher A. Meek, Kirkland, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/147,927

(22) Filed: Jun. 27, 2008

(51) Int. Cl. G06Q 30/00

(52) U.S. Cl. 705/80

(57) ABSTRACT

The claimed matter provides systems and/or methods that enable sellers and buyers to take mutual advantage of the relationship of the location of seller outlets to routes that mobile buyers take to other destinations. The system can include devices that identify sellers capable of fulfilling a buyer's product or service requirements, generate value functions for the seller based on bidding functions acquired from the seller and related to the product or service requirements of the buyer, compare the value functions associated with multiple sellers to identify a successful seller, and notify the buyer of the location of the successful seller by modifying a route to a pre-established destination to include directions to the successful seller.

### BACKGROUND

Increasing numbers of people in mobile settings have access to devices with processing capabilities (e.g., smart phones, cell phones, personal digital assistants, laptop computers, notebook computers, Tablet PCs, and the like) that can be connected to network topologies and clouds, such as the Internet. To date, such connectivity has been harnessed largely for personal communication, Web access, and routing. Nevertheless, access to connected computing in mobile environments will eventually evolve to play a more central role in people's lives.

There have been several attempts to address and apply opportunistic planning in mobile settings. One effort provided a system that assisted people with cognitive deficits with transportation decisions by identifying opportunities for more efficient transportation routes and generating plans that directed them towards their goals. Another effort modeled user interests to create policies to maximize utility of users in shopping domains. Yet a further effort developed a prototype operating as a location-based negotiation support system on mobile devices to guide users to the best promotions within a region. Nevertheless, none of the foregoing efforts have addressed and or overcome the issues disclosed and illustrated herein.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter presents mechanisms, architectures, and implementations that address challenges with mobile opportunistic commerce on markets and mechanisms that support procurement of goods and services in mobile settings and/or environments. The subject matter as claimed extends core concepts from research to interactions between mobile buyers and brick and mortar businesses that have geographically situated retail outlets. The claimed subject matter also provides efficient mechanisms, infrastructure, and automation that can enable sellers and buyers to take joint advantage of the relationship of the locations of retail outlets to the routes of mobile buyers who can have another or alternative primary destination. Accordingly, the subject matter as claimed can promote automated vigilance about opportunities to buy and sell, and support negotiations on the joint value to buyers and sellers of people making or taking detours and diverging from their prescribed paths to acquire services and/or commodities. In order to facilitate the foregoing, the claimed subject matter can apply auction mechanisms to personal procurement settings by analyzing the dynamics of the cost to buyers based at least in part on pre-existing plans, location, and overall context. Moreover, the claimed subject matter provides mechanisms for auctions in both single item and combinatorial settings that take into consideration personal inconvenience costs within time sensitive dynamic markets, commitments to engage, a mix of human and agent initiatives, and challenges with privacy and fairness.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that facilitates and effectuates mobile opportunistic commerce in support of procurement of goods and services in mobile environments in accordance with the claimed subject matter.

FIG. 2 provides a more detailed depiction of a buyer component that facilitates and effectuates mobile opportunistic commerce in accordance with an aspect of the claimed subject matter.

FIG. 3 provides a more detailed depiction of a seller component that facilitates and effectuates mobile opportunistic commerce in accordance with an aspect of the claimed subject matter.

FIG. 4 provides a more detailed depiction of an auction component that facilitates and effectuates mobile opportunistic commerce in accordance with an aspect of the claimed subject matter.

FIG. 5 illustrates a flow diagram of a machine implemented methodology that effectuates and facilitates mobile opportunistic commerce in accordance with an aspect of the claimed subject matter.

FIG. 6 provides depiction of a product ontology in accordance with an aspect of the subject matter as claimed.

FIG. 7 illustrates yet a further ontology utilized in accordance with an aspect of the claimed subject matter.

FIG. 8 illustrates a block diagram of a computer operable to execute the disclosed system in accordance with an aspect of the claimed subject matter.

FIG. 9 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

It should be noted at the outset that while the claimed subject matter can be applied to many and diverse applications and aspects, the focus herein is directed towards extending market-centric mechanisms to commerce in mobile environments. In particular, the subject matter as claimed explores a world where computing environments work to enhance the efficiency of planned and unplanned commerce between mobile buyers and disparate geographically dispersed businesses. The claimed subject matter thus provides efficient mechanisms, infrastructure, and automation that can enable both sellers and buyers to take mutual advantage of the relationship of locations of retail establishments to points on the routes of mobile buyers who may have preplanned primary destinations.

The approach adopted by the claimed subject matter differs from existing work on mobile commerce by replacing single agent decision-making with market centric machinery that matches mobile buyers and dynamic sellers via an auction center. Moreover, the subject matter as claimed extends existing work on auctions to personal procurement settings that consider the dynamics of the costs to buyers based on pre-existing plans, location, and overall context. Further, the subject matter as claimed integrates the analysis of personal inconvenience costs within time sensitive dynamic markets by pairing buyers with sellers that offer the highest combined value in terms of offered price, preferences of the buyer, and the required additional costs in time and distance to access the seller. Based at least in part on sellers standing/reputation or dynamically computed buyer interests and/or requirements, purchase requests from a buyer proxy can be made available to sellers. A mediating mechanism can open a reverse second-price sealed-bid auction with a set of feasible sellers, and construct a value function for each seller by combining buyer preferences with time, distance costs, and seller bids. The transaction can typically be finalized with the seller with the highest value on the second lowest offered cost. Additionally, the claimed subject matter considers and takes into account single item, combinatorial, and multi-attribute settings as well as non-myopic decision making. Further, the matter disclosed and claimed herein also considers and overcomes problems related privacy and fairness, as well as issues that can arise when proxies are deputized with the ability to make binding transactional commitments on behalf of individuals.

The claimed subject matter thus enables both buyers and sellers to take joint advantage of the relationship of locations and routes of mobile buyers to locations of retail establishments/outlets, and provides machinery for ongoing background negotiations on the joint value to both buyers and sellers or potential buyers taking unplanned divergences in their paths to acquire services and commodities.

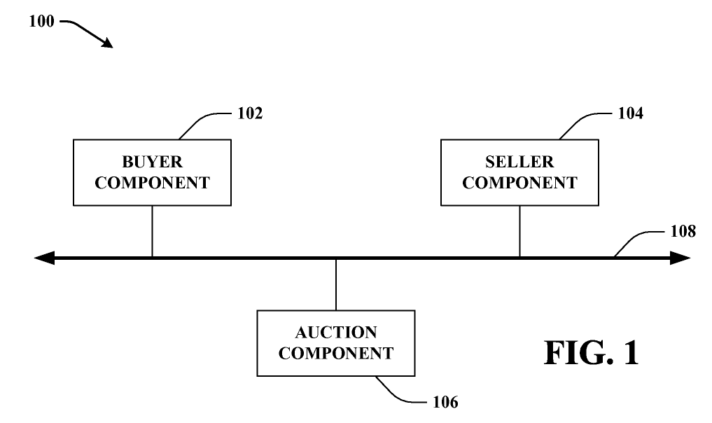

Turning now to FIG. 1 that illustrates a system 100 that effectuates and facilitates mobile opportunistic commerce that supports the procurement of goods and services in mobile environments. System 100 can have particular focus on the challenge of searching for ways to continually satisfy an individual's background goals in a mobile setting by inferring or accessing active goals, and then considering the costs and/or benefits of adding alternate goal-satisfying locations as waypoints to the individual's route. As a brief illustration consider the opportunistic purchase of fuel for a car. System 100 allows individuals to specify pre-conditions for active goals. For the case of handling fuel needs, for instance, an individual can specify that the goal of purchasing gasoline becomes active when the quantity of fuel dips below a threshold. When this goal (or other goals) is activated, system 100 accesses or infers the destination and performs an ongoing search over all feasible service stations. Choices for candidate waypoints can be ranked by expected value, taking into consideration the pricing at candidate locations, and the context sensitive cost to users of the time and resources associated with diverting from an ideal route to a destination through different candidate waypoints. The cost analysis undertaken by system 100 considers not only the advertised price of the product, service or an experience, but also the additional costs in time and distance to access the waypoints. In summary, system 100 can follow five main acts: (1) identify active goals; (2) infer or access the destination of the individual; (3) infer context-sensitive marginal costs of time to the individual; (4) perform geospatial search of feasible locations that satisfy an individual's goals; and (5) perform cost-benefit analysis for each of the options to identify the best candidate. Background goals and preconditions for activating goals can be authored within a goals-and-preferences tool, for example. Such a tool can enable users or individuals to express policies for one-time and such diverse recurrent needs as groceries, gasoline, meals, and haircuts, for instance. Time can also be an important resource and typically is one of the major factors influencing the value of opportunities. For example, a user may be willing to trade off increases in the distance and time added to a trip so as to achieve better prices when the cost of time is small, but not when the user has a near-term deadline that would make such a foray very costly.

System 100 can employ probabilistic models for the cost of time associated with diverging from an ideal path to a destination via candidate added waypoints. The cost model considers as input, time of day, day of week, and sets of attributes about users' commitments drawn from an online appointment book, for example. The probabilistic model for the cost of time can be learned from user annotated training data via a Bayesian structure search. A destination analyzer can access, predict, or guess the intended destination of a user in motion via direct input, a predefined set of miles that consider routes by time of day and day of week, from calendar information, or from a probabilistic estimation from a partial trajectory. System 100 can perform geospatial searches over feasible locations that can satisfy active goals. The set of candidate locations can be accessed from modalities, databases, and/or mechanisms designed to effectuate and or facilitate geographical visualization and analysis of data. Further, given the current location and destination of the user, system 100 can compute updated routes to the destination by adding candidate locations as waypoints and performing A* searches. For practical reasons, the number of candidate locations identified by system 100 can be limited by the maximum distance the buyer is generally willing to detour from the original prescribed course.

System 100 can perform an economic analysis to evaluate the total cost of each option recognized by the geospatial search. The product costs can be accessed from a pricing database, for example. System 100 can compute a divergence cost for each possible option by combining the amount of time and distance added to the trip with a dynamic time-cost model associated with the user. The divergence cost or the cost to undertake a detour can be added to the product cost to infer the net cost of an opportunity. System 100 can thereafter output or produce the option with the lowest total cost to the buyer and can subsequently notify mobile travelers about the best opportunities and transmit updated directions accompanied with summaries of the total cost-benefit analysis.

System 100 as illustrated can include buyer component 102 responsible for modeling the goals, preconditions, and preferences of a buyer prior to a trip, seller component 104 that enables sellers to place bids dynamically via updates in pricing, and auction component 106 that can receive dynamic bids from sellers and applies auction rules to determine the best opportunity for the buyer. Auction component 106 can utilize a destination analysis tool and a geospatial search component to identify sets of feasible sellers and to evaluate the divergence costs accordingly. Further, auction component 106 plays the role of an unbiased, impartial, and trusted mediator between buyer component 102 and seller component 104, and attempts to pair mobile buyers with the seller that offers the highest value in terms of offered price, preferences, and minimal inconvenience costs to the buyer. Moreover, as illustrated, buyer component 102, seller component 104, and auction component 106 can be in continuous and/or operative or sporadic and/or intermittent communication with one another via network topology and/or cloud 108.

Buyer component 102 can be implemented entirely in hardware and/or a combination of hardware and/or software in execution. Further, buyer component 102 can be incorporated within and/or associated with other compatible components. Additionally, buyer component 102 can be any type of machine that includes a processor and is capable of effective communication with network topology and/or cloud 108. Illustrative machines that can comprise buyer component 102 can include cell phones, smart phones, laptop computers, notebook computers, Tablet PC's, consumer and/or industrial devices and/or appliances, hand-held devices, personal digital assistants, multimedia Internet mobile phones, multimedia players, automotive components, avionics components, and the like.

Seller component 104, like buyer component 102, can be implemented entirely in hardware and/or as a combination of hardware and/or software in execution. Further, seller component 104 can be any type of engine, machine, instrument of conversion, or mode of production that includes a processor and is capable of effective and/or operative communications with network topology and/or cloud 108. Illustrative instruments of conversion, modes of production, engines, mechanisms, devices, and/or machinery that can comprise and/or embody seller component 104 can include desktop computers, server class computing devices and/or databases, cell phones, smart phones, laptop computers, notebook computers, Tablet PCs, consumer and/or industrial devices and/or appliances and/or processes, hand-held devices, personal digital assistants, multimedia Internet enabled mobile phones, multimedia players, and the like.

Similarly, auction component 106, like buyer component 102 and seller component 104, can be implemented entirely in hardware and/or as a combination of hardware and/or software in execution. Further, auction component 106 can be any type of mechanism, machine, device, facility, and/or instrument that includes a processor and is capable of effective and/or operative communications with network topology and/or cloud 108. Mechanisms, machines, devices, facilities, and/or instruments that can comprise auction component 106 can include Tablet PC's, server class computing machines and/or databases, laptop computers, notebook computers, desktop computers, cell phones, smart phones, consumer appliances and/or instrumentation, industrial devices and or components, hand-held devices, personal digital assistants, multimedia Internet enabled phones, multimedia players, automotive components, satellites and/or satellite equipment, and the like.

Network topology and/or cloud 108 can include any viable communication and/or broadcast technology, for example, wired and/or for wireless modalities and/or technologies can be utilized to effectuate the claimed subject matter. Moreover, network topology and/or cloud 108 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and distributed—and/or any combination, permutation, and/or aggregation thereof. Additionally, network topology and/or cloud 108 can include or encompass communications or interchange utilizing Near-Field Communications (NFC) and/or communications utilizing electrical conductance through the human skin, for example.

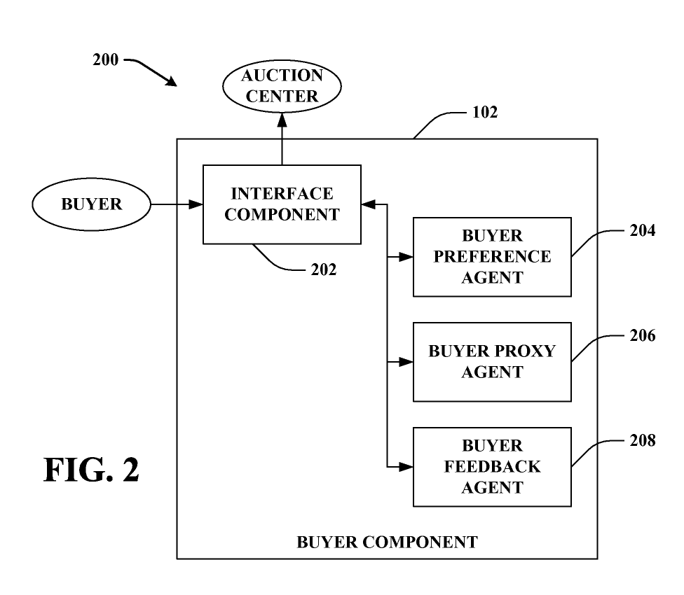

FIG. 2 provides a more detailed depiction 200 of buyer component 102 that in accordance with a claimed aspect facilitates and/or effectuates mobile opportunistic commerce that supports procurement of goods and services in mobile environments. Buyer component 102 as illustrated can include interface component 202 (hereinafter referred to as “interface 202”) that can receive and/or disseminate, communicate, and/or partake in data interchange with a plurality of disparate sources and/or components. For example, interface 202 can receive and transmit data from, and to, a multitude of sources, such as, for instance, data associated with auction component 106, for example, information related to products, services, and/or pricing. Additionally and/or alternatively, interface 202 can obtain and/or receive data associated with a plethora of other information, such as, for example, user names and/or passwords, sets of encryption and/or decryption keys, client applications, services, users, clients, devices, and/or entities involved with a particular transaction, portions of transactions, and thereafter can convey the received or otherwise acquired information to one or more of buyer preference agent 204, buyer proxy agent 206, and/or buyer feedback agent 208 for subsequent utilization, processing, and/or analysis. To facilitate its ends, interface 202 can provide various adapters, connectors, channels, communication pathways, etc. to integrate the various components included in system 200, and more particularly, buyer component 102 into virtually any operating system and/or database system and/or with one another. Additionally and/or alternatively, interface 202 can provide various adapters, connectors, channels, communication modalities, and the like, that can provide for interaction with various components that can comprise system 200, and/or any other component (external and/or internal), data, and the like, associated with system 200.

As depicted buyer component 102 can include distinct agents (e.g., buyer preference agent 204, buyer proxy agent 206, or buyer feedback agent 208) responsible for modeling the goals, preconditions, and preferences of the buyer prior to a trip. These agents can identify current goals, provide the destination and time-cost while the user is traveling, and collect feedback about the experience after the buyer interacts with a seller. Buyer preference agent 204 can be arranged in such a manner as to allow buyers to represent goals and preconditions, the cost of additional time required to satisfy a goal, and preferences for purchasing from different sellers. Typically, the buyer can indicate preferences (e.g., via interface 202) to buyer preference agent 204 before starting a trip. The accuracy and quality of the information received by buyer preference agent 204 can adversely or beneficially influence the performance of the claimed matter.

Buyer proxy agent 206 can be responsible for assessing the current state of the buyer while the buyer is mobile (e.g., is traveling and/or is in transit). Buyer proxy agent 206 can utilize sets of goals and preconditions accessed from buyer preference agent 204 to autonomously recognize sets of items, services, or experiences that the buyer is interested in purchasing and acquiring and further can employ destination analysis and/or time-cost models to make further inferences regarding goals, locations, and/or buying preferences. For the current state of the buyer, buyer proxy agent 206 can construct a time-cost function T to estimate the time-cost of the buyer with respect to the nearest deadline. Thus, if the nearest deadline is d minutes in the future, time cost per minute before the deadline cₙ and after the deadline c_{d}, the time-cost function T can predict the cost of t minutes as:

$$T ( t ) = \{ \begin{matrix}{tc}_{n} & t < d \\ d {c}_{n} + ( t - d ) {c}_{d} & otherwise\end{matrix}$$

Buyer feedback agent 208 can be designed as a tool that captures the preferences of the buyer about different sellers. Buyer feedback agent 208 can collect rating values and waiting times from the buyer immediately after an interaction with a seller. The rating values can be represented in monetary terms (e.g., US Dollars, Euros, etc.) and can show how much extra the buyer is willing to pay in monetary terms to have a transaction with a seller. The feedback information acquired by buyer feedback agent 208 can be persisted to storage media and utilized in evaluating the value of the seller for future opportunities.

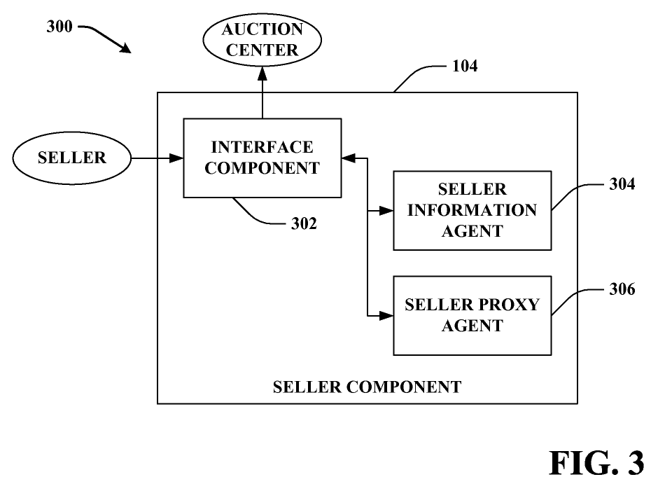

FIG. 3 provides a more detailed illustration 300 of seller component 104 that in accordance with another aspect of the claimed subject matter facilitates and/or effectuates mobile opportunistic commerce that supports procurement of goods and services in mobile environments. Seller component 104, like buyer component 102, can include interface component 302 (hereinafter referred to as “interface 302) that can receive and/or disseminate, communicate, and/or partake in data interchange with a plurality of disparate sources and/or components, such as auction component 106. Because much of the configuration and operation of interface 302 is substantially similar to that described with respect to interface 202, a detailed description of such features has been omitted to avoid needless repetition and for the sake of brevity and conciseness.

As depicted seller component 104 can include seller information agent 304 that can be responsible for listing the products, services and experiences offered by a seller, and communicating seller-specific transaction rules or regulations (e.g., fees associated with cancellations). Such information can be stored in databases affiliated with auction component 106 or can be persisted locally on storage devices associated with seller component 104.

Further, seller component 104 can also include seller proxy agent 306 that can be invoked, for example, by auction component 106 when a seller is selected as one of the feasible options during a geospatial search. Seller proxy agent 306 can be responsible for providing the bidding functions of the sellers. For example, seller proxy agent 306 can support one or two dimensional bidding functions to define pricing values for different quantities.

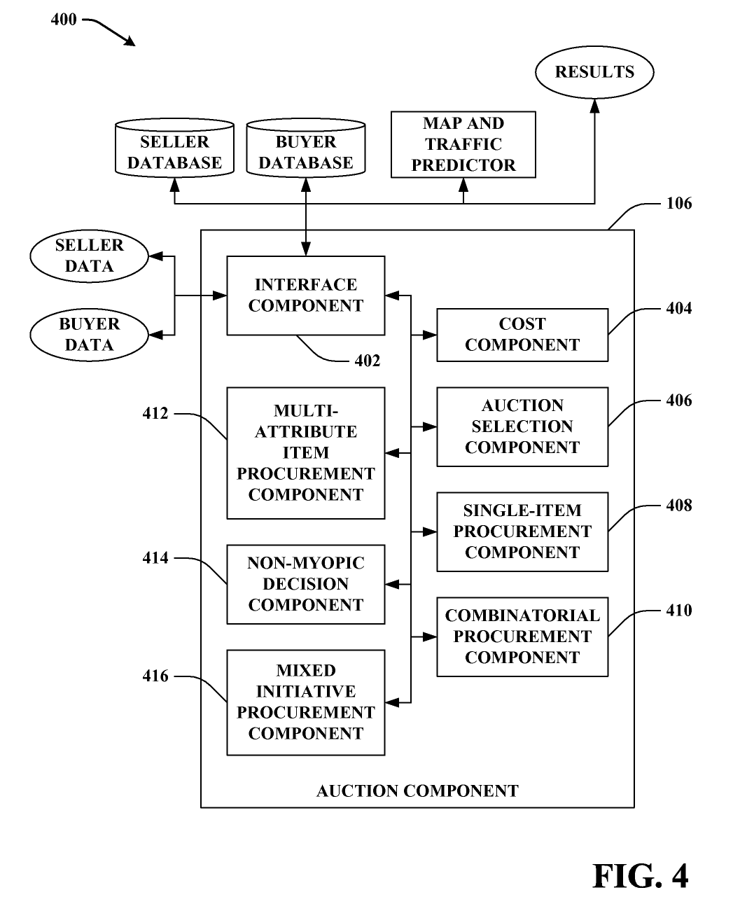

FIG. 4 provides further illustration 400 of auction component 106 that facilitates and/or effectuates mobile opportunistic commerce supportive of the procurement of goods and services in mobile environments. Auction component 106, like buyer component 102 and seller component 104, can include interface component 402 (hereinafter referred to as “interface 402”) that can receive and/or disseminate, communicate, and/or partake in data interchange with a plurality of disparate sources and/or components, such as seller component 104 and/or buyer component 102. Because much of the configuration and operation of interface 302 can be substantially similar to that described with respect to interface 202 and interface 302, a detailed description of such features has been omitted for the sake of brevity.

Auction component 106 can be connected to buyers and sellers (e.g., buyer component 102 and seller component 104) through respective proxy and information agents (e.g., buyer preference agent 204, buyer proxy agent 206, buyer feedback agent 208, seller information agent 304, and seller proxy agent 306) and it can store information provided by the buyer and seller information agents and buyer satisfaction data in its affiliated and/or associated local and/or remote databases. During a session, for example, auction component 106 can be invoked by buyer proxy agent 206 to open an auction with feasible sellers that can satisfy a buyer's goals. Buyer proxy agent 206 can define the product or service that a buyer is interested in purchasing, and can provide destinations and dynamic time-cost functions of the buyer. Auction component 106 can then perform a geospatial search of waypoints, compute the overall value of taking different modified routes to the buyer's primary destination, and identify a set of sellers to contact. Sellers' proxies (e.g., seller proxy agent 306) can be notified about the auction without revealing the identity, destination, preferences, and/or the time cost to the buyer, and can be requested to submit their bidding functions to auction component 106. Once seller proxies have submitted their bids to auction component 106, auction component 106 can construct a value function for each seller by combining buyer preferences with time, distance costs, and seller bids. Auction component 106 can apply auction miles to determine a winner and the amount of payment (e.g., the strike price), notify the buyer about the deal, and provide updated driving directions.

Auction component 106 can be constructed to employ a market-centric design and to enhance the efficiency of mobile commerce, given that buyers agree to share preferences, destinations, and time costs, and sellers dynamically bid on prices. Auction component 106 operates under the assumption that participants in the market are willing to reveal their private information to a trusted impartial third party (e.g., auction component 106) if they can achieve higher efficiencies without making their private information public. Typically, in mobile commerce settings, protecting privacy is critical and crucial as the market is open to recurring transactions and private information can be utilized to strategize about future transactions. Thus, both buyers and sellers need to trust the impartial third party (e.g., auction component 106). Accordingly, auction component 106 can be designed to generate trust, to be fair, and to respect the privacy of both sellers and buyers. Auction component 106 therefore only reveals necessary and sufficient information to the participants. During the auction process, the identity, preferences, destination, and time-cost to the buyer is typically not revealed to the sellers, and sellers are generally forced to bid on prices regardless of the identity of the buyer. Similarly, the bidding functions of the sellers are generally not shared with the buyer or with other sellers. Auction component 106 discloses the final revenue of the transaction to the winning seller and buyer; other sellers are generally only notified that they were not winning bidders.

In order to ensure that the claimed and disclosed subject matter remains as healthy and as objective as possible in order to maximize the number of members and preserve existing memberships, maintaining the privacy of all parties can be one paramount objective. Even though the paired winning seller and buyer know the final revenue of the transaction, the nature of the auction mechanism makes it difficult to use this information to predict the bidding functions of sellers. As auction component 106 implements a second-price sealed-bid auction, the final revenue generally is the summation of the second lowest bidder's bid and the personal cost to the buyer. The personal cost to the buyer typically is a combination of additional time and distance costs and buyer preferences about the seller. Generally, the identity of the second lowest bidder is concealed.

Auction component 106 can adopt rules to prevent buyers deceiving the system to explore bidding prices of the sellers. Generally, a buyer is apprised of the results of an auction when the transaction is completed. Typically, the buyer has to pay a cancellation fee to terminate an agreement made during automated negotiations. Further, there can exist a lower bound on the amount of product for which a buyer can initiate an auction. To ensure the fairness of auction component 106, auction component 106, or entities that control auction component 106, are generally not awarded a portion of the transaction revenue as is typical in auction situations, but can rather receive predetermined membership fees from seller and buyer members. Auction component 106 can utilize a feedback mechanism to monitor sellers' behavior and to ensure that sellers obey the terms of their agreements and provide good quality of service. Once the transaction has completed, buyer feedback agent 208 can send a rating and estimated waiting time about the recent transaction. These values can then be stored in a sellers database associated with auction component 106 and thereafter utilized in future winning determinations. Sellers with high waiting times or poor quality of service can be penalized by the system by auction component 106 commensurately increasing buyer personal costs associated with those sellers.

It should be noted that the winner-determination rules of auction component 106 can be designed to ensure individual rationality of sellers and buyers. The final value of the auction is never worse than the value that a buyer would receive had the buyer not enrolled in the auction and was to purchase the product in a normal manner. Similarly, the second-price sealed-bid auction guarantees that if the seller bids the true evaluation, the utility of the winning seller is not always a non-negative.

In personal procurement domains, price is typically not the only factor that determines the value of the deal. Within opportunistic situations, the additional time and travel required may be as important as finding the lowest price. A buyer with a low cost of time (e.g., one who does not have looming deadlines) may prefer traveling a longer way to obtain a good price, whereas a buyer with a high cost of time may prefer a more expensive price available via a closer seller. Accordingly, a personal cost model that considers several buyer-specific factors can be constructed and utilized by auction component 106. Further, auction component 106 can utilize modified auction models to take buyer inconvenience costs into account.

In light of the foregoing overview, auction component 106 can include and/or employ the following components in accordance with aspects of the claimed subject matter. Adding waypoints to a trip can introduce extra time and fuel costs for the buyer and these personal costs can affect the value that the buyer receives from a transaction. Accordingly, cost component 404 can combine the extra time and fuel cost with buyer preferences to estimate the total inconvenience costs associated with adding a candidate seller as a waypoint on a trip to a primary destination. For instance, the time cost for adding seller sᵢ to a trip can be determined as the difference between a time cost with and without a stop sᵢ. The probabilistic time-cost model can be provided by buyer proxy agent 206, and cost component 404 can utilize a service designed to effectuate and/or facilitate geographical visualization and/or analysis of data to estimate the travel duration.

Given that Δt can represent the estimated travel duration of the original route, cost component 404 can compute the updated travel duration (e.g., Δtᵢ+wᵢ) by adding si as a waypoint and including the estimated waiting time wᵢ. Cost component 404 can feed the time-cost model with Δt and (Δtᵢ+wᵢ) values and can utilize a difference in the two estimations to predict the time cost for adding sᵢ to the trip. Similarly, the distance cost can be the divergence in miles for adding sᵢ as a waypoint. Thus, if Δd represents the original distance to be traveled, Δdᵢ denotes the distance to be traveled with a stop at sᵢ, c_{g} the fuel cost in dollars for traveling one mile, rating rᵢ of seller sᵢ represents how much extra the buyer is willing to pay in dollar terms to make a deal with sᵢ (e.g., a sign of the quality of service the buyer receives from a particular seller), the maximum distance that the buyer is willing or able to travel (e.g., due to limited fuel) is represented by dₘₐₓ, the field of possible and feasible sellers is limited to those that are in close proximity, and the personal cost becomes infinite when the total trip distance exceeds the maximum allowed distance. Then cost component 404 can combine the time and distance costs, and rating values to generate and utilize a personal inconvenience cost function for seller sᵢ as:

$${PC}_{i} = \{ \begin{matrix}∞ & Δ {d}_{i} > {d}_{max} \\ T ( Δ t + {w}_{i} ) - T ( Δ t ) - {r}_{i} + & \\ ( Δ {d}_{i} - Δ d ) {c}_{g} & otherwise\end{matrix}$$

Typically the rules of the auction can determine the winner and final revenue, and can influence the behaviors of the participants. Accordingly, auction selection component 406 needs to select from different auction types. For example, auction selection component 406 can choose to employ an iterative auction, for example English (descending) or Dutch procurement auctions in which bidders receive continuous price signals. Bidding in an English auction starts from a high price point and bidders offer monotonically decreasing bids until one seller remains. The transaction is typically sealed with the seller offering the lowest price. Dutch auctions are the opposite of English auctions in the sense that bidding starts from a low price point and increases monotonically. The deal is concluded with the first seller that accepts the announced price. The optimal strategy in English auctions is to bid on prices above the true evaluation. The Dutch auction is strategically more challenging for bidders, as the bidders are required to act without receiving pricing signals, therefore strategize about other sellers. Additionally and/or alternatively auction selection component 406 can choose to implement first-price sealed-bid and/or second-price sealed-bid auctions which typically are single round auctions where bidders submit sealed bids. In both sealed-bid auction mechanisms, the winner is the bidder with the lowest price offer. The payment of the first-price sealed-bid is the lowest offered price whereas the winner is paid the second lowest offer in second-price sealed-bid auctions.

The Revenue Equivalence Theorem states that, while these auction mechanisms (e.g., English (descending), Dutch procurement, first-price sealed-bid, and second-price sealed-bid auctions) are significantly diverse, the mechanisms nevertheless generate the same revenue under the assumption that the bidders are a risk-neutral, bidder evaluations are independent, and bidders are symmetric. However, it has been found, that second-price sealed-bid auctions are generally strategy-proof for one-time interactions of buyers and sellers, the payment the winner receives is independent of its bid, and revealing the correct evaluation maximizes the chance of winning. The dominant strategy therefore is to be truthful and reveal a true evaluation function. On the contrary, first-price sealed-bid auctions are typically not strategy-proof mechanisms; bidders participating in these auctions need to strategize about other sellers in order to maximize final revenue.

With mobile opportunistic commerce, typical bidders are such retailers as gas stations, grocery stores, and movie theaters; these entities are generally not experts in strategy. Generating nearly optimal bids in Dutch or in first-price sealed-bid auctions can be potential barriers that can make such sellers cautious about entering the market. For one-time situations, the English and second-price auctions can eliminate the expensive overhead of strategizing about other bidders, and thus, it can be easier for brick and mortar retail establishments to rationalize engagement in the electronic market under such conditions.

Sellers can be evaluated in terms of their total costs, which can be a combination of the personal cost for a particular seller, and the bid that the seller offers. The winner of an English auction generally is the seller that offers the lowest total price. A seller maximizes the chance of winning by minimizing the personal cost to the buyer of its offering. The buyer's personal cost for a candidate seller can be minimized if the buyer follows the path that induces the lowest divergence from the original path. It should be noted that it is to the advantage of all sellers to have evaluations of personal cost take place in relationship to the destination point. Terminating the auction at departure can minimize the total cost to the buyer. In one-time situations, the dominant strategy for bidders is to bid up to their true evaluation (true bidding function combined with minimum personal cost) and to terminate the auction before the buyer starts the trip. In one-time personal procurement auctions without instant price fluctuations, the English auction produces an identical outcome as a second-price sealed-bid auction.

Nevertheless, English auctions typically can have high communication requirements. At every decrement, one seller bids, and all sellers are notified about the new bid. When the auction terminates, all participants are then informed of the outcome of the auction. Thus, given a starting price of the auction p_{high}, a price dropping d at each decrement, a final price of p_{final}, and with n sellers bidding, the number of messages that need to be communicated can be

$$( n + 1 ) \frac{{p}_{high} - {p}_{final}}{d} + ( n + 1 ) .$$

The communication requirements of second-price sealed-bid auctions in contrast can be significantly lower. For instance, on the progress of an auction, n bidders send their bids to auction selection component 406, and in response auction selection component 406 can notify the participants. The total number of message in a second-price sealed-bid auction is typically 2n+1. Since communication costs can be important in mobile settings and for the reasons elucidated above auction selection component 406, when given the latitude, can opt to utilize and implement second-price sealed-bid auctions in the context of mobile opportunistic commerce.

Auction selection component 406 can further opt to implement second-price sealed-bid auctions because of its three properties for one-time auctions: efficiency of final outcome, strategy-proofness and truthfulness, and low communication demands. While market mechanisms can be affected by the vulnerabilities of second-price sealed-bid auctions, these types of auctions can be open to collusion of sellers, and that revealing true evaluations may not be the dominant strategy when extended to repeated auctions, auction selection component 406 nevertheless can overcome these shortcomings to provide truthfulness in repeated interactions, and to prevent collusion.

Previous work on procurement auctions has introduced models that combine supply-chain costs with prices to minimize the total cost. These models typically have focused on industrial procurements where the important attributes have been delivery time, availability of spares, maintenance, etc. The matter as disclosed and claimed herein extends these auction models to personal procurement settings providing an auction model that applies the rules of the second-price sealed-bid auction to mobile opportunistic commerce. The system, or more particularly auction component 106 considers both the bidding prices of the sellers and the costs associated with the personal inconvenience to buyers. Auction component 106 matches the buyer with the seller that offers the highest value and in doing so generates nonnegative profit to the seller. Moreover, auction component 106 achieves or improves the baseline outcome which is the best deal achieved among the standard prices announced in the open market (e.g., outside of the auction). In facilitating the foregoing, auction component 106 realizes a volume discount auction, receives bids as a function of quantity, and determines the quantity and price that maximizes the comprehensive value to the buyer.

Winner determination for general auction settings is generally considered NP-hard (e.g., nondeterministic polynomial-time hard). Accordingly, single item procurement component 408 can utilize two realistic assumptions that are justified by the personal procurement domain so that it can determine the winner of an auction efficiently. Each supplier is assumed to have infinite supply of goods, and can expect bidding prices to drop with increasing quantities. To minimize the total cost, buyers purchase the whole quantity of an item from a single seller. Under these assumptions, winner determination functions employed by single item procurement component 408 can be modified to apply second-price sealed-bid auctions in the following manner.

If a set of all feasible sellers identified by a geospatial search is denoted by S and sellers are evaluated in terms of the total cost (TC) value they offer, the best deal available to the buyer without entering into the auction can be used by single item procurement component 408 as the baseline value to evaluate the profit of the auction. Further, TC_{B} can represent the total cost of the baseline deal where pᵢ is the announced price of the seller, sᵢ ∈ S, q is the quantity of purchase, and qₘₐₓ is the maximum amount the buyer is willing to purchase. Decision-theoretic analysis can thereafter be applied by single item procurement component 408 to find a seller w_{B}(q) that offers the minimal total cost to the buyer for quantity q in traditional markets acting without an auction.

$${TC}_{B} ( q ) = \{ \begin{matrix}{min}_{1 \leq i \leq \vert S \vert} \{ {PC}_{i} + {p}_{i} q \} & q \leq {q}_{max} \\ {TC}_{B} ( {q}_{max} ) & otherwise\end{matrix} \\ {w}_{B} ( q ) = arg {min}_{1 \leq i \leq \vert S \vert} \{ {PC}_{i} + {qp}_{i} \}$$

The set of member sellers M that is a subset of S can be included in the auction. Accordingly, single item procurement component 408 can receive bidding functions bⱼ from each seller mⱼ ∈ M, bⱼ is a function of the offered price with respect to quantity q. Given that the personal cost of seller mⱼ can be PCⱼ, the total cost (TCⱼ) of mⱼ can be determined as,

TCⱼ(q)=PCⱼ+bⱼ(q)q

The value of having seller mⱼ ∈ M in the auction can be modeled by the value function Vⱼ. Vⱼ represents the total cost reduction gained by preferring mⱼ to w_{B}, which single item procurement component 408 can utilize,

Vⱼ(q)=TC_{B}(q)−PCⱼ−bⱼ(q)q

For the fuel purchase domain, the amount of fuel (qⱼ) that the buyer spends to get to the location of seller mⱼ can change the amount of fuel that needs to be purchased. The cost of fuel can be included in the PC function. The extra demand, qⱼ, can affect the bidding price of mⱼ, and can be included by single item procurement component 408 in the auction model. TCⱼ and Vⱼ functions as utilized by single item procurement component 408 therefore can be redefined as:

TCⱼ(q)=PCⱼ+bⱼ(q+qⱼ)q

Vⱼ(q)=TC_{B}(q)−PCⱼ−bⱼ(q+qⱼ)q

In second-price auctions, the outcome of the auction is the second highest value provided by the sellers. Thus, auction component 106, and more particularly single item procurement component 408, can construct and employ an auction outcome function (AO) that represents the value that the buyer gets for quantity q. Single item procurement component 408 can determine the quantity (q*) that maximizes the value that the buyer receives. The winner of the auction (w₁) typically is a seller that offers the best value for quantity q*. Payment generally can be determined by single item procurement component 408 with respect to the seller w₂ that offers the second highest value for quantity q*.

$$V ( q ) = \{ {V}_{1} ( q ) , … , {V}_{j} ( q ) , … \} , \\ 1 \leq j \leq \vert M \vert$$

$$AO ( q ) = max ( \{ {V}_{j} ( q ) : {V}_{j} ( q ) < max ( V ( q ) ) \} )$$

$${q}^{*} = arg {max}_{q \leq {q}_{max}} \{ AO ( q ) \}$$

$${w}_{1} = arg {max}_{1 \leq j \leq \vert M \vert} \{ {V}_{j} ( {q}^{*} ) \}$$

Single item procurement component 408 ensures that the buyer is not worse off by engaging in the auction. Before terminating the auction, single item procurement component 408 can compare the final value of the auction with a baseline value to determine if the auction is profitable. If AO(q*) is positive, the auction is more profitable than the baseline outcome, single item procurement component 408 can select w₁ as the winner, ascertain the total cost for the buyer to be (TC_{w}_{₂}(q*)), and determine payment to the winner as (TC_{w}_{₂}(q*)−PC_{w}_{₂})). Otherwise, single item procurement component 408 can recommend to the buyer that the transaction with w_{B} and payment of (TC_{B}−PC_{w}_{_{B}}) is the more preferable and profitable alternative.

To provide more context for the foregoing, the following fuel purchase example is presented to illustrate winner determination as effectuated by single item procurement component 408. Buyer proxy agent 206 can identify a fuel need and invokes auction component 106 by delivering the original route and the time cost function. Auction component 106, and in particular single item procurement component 408, can undertake a search of feasible sellers. In this instance, four feasible sellers have been identified. Sellers 0, 1, and 3 are located in close proximity to the original path and as such they yield lower personal costs but higher prices. Seller 2 is more competitive; although located farther away from the destination, the seller offers the best price. Sellers 1, 2, and 3, for the purposes of this illustration have been deemed to be member sellers.

| | Member | pᵢ | bᵢ | PCᵢ | dᵢ |
|---|---|---|---|---|---|
| Seller 0 | No | 3.0 | | 10 | 2 |
| Seller 1 | Yes | 2.9 | C₁ | 10 | 2 |
| Seller 2 | Yes | 2.6 | C₂ | 20 | 5 |
| Seller 3 | Yes | 2.91 | C₃ | 13 | 2 |

Single item procurement component 406 can construct a baseline function using the annotated prices, pᵢ. Sellers that are members of the market (e.g., sellers 1, 2, and 3) can submit their bidding functions C₁, C₂, and C₃ to single item procurement component 408. Single item procurement component 408 can then compute value functions for each of the member sellers (e.g., sellers 1, 2, and 3). The quantities for which the auction outcome yield higher values than the baseline can be labeled as a Profitable Auction Region, a region in which a possible successful bid can be located and identified.

Auction component 106 can also provide opportunities to buyers and sellers in combinatorial purchase situations where multiple items are exchanged in bundles. Accordingly, if buyer proxy agent 206, for example, determines that the buyer is interested in a set of items, auction component 106, and more particularly combinatorial procurement component 410, can find the combination of sellers that provide the best value to the buyer.

Given that the set of items the buyer is interested in is X={x₁, x₂, . . . , xₙ}, Sᵢ the set of feasible member sellers capable of supplying xᵢ, combinatorial procurement component 410 can compute and employ personal and total cost functions for every combination cⱼ={s₁, s₂, . . . , sₙ} such that s₁ ∈ S₁, . . . , sₙ ∈ Sₙ. The set of all possible combinations can be represented as C. Combinatorial procurement component 410 can add every seller in cⱼ as waypoints to the original trip and can estimate the expected travel distance (Δtⱼ) and distance (Δdⱼ) for the updated route. The personal cost of cⱼ can be the combination of extra time and distance costs combined with additive waiting times (Σwᵢ) and preferences (Σrᵢ).

$${PC}_{{c}_{j}} = \{ \begin{matrix}∞ & Δ {d}_{j} > {d}_{max} \\ T ( Δ {t}_{j} + {\sum }_{{s}_{i} ∈ {c}_{j}} {w}_{i} ) - T ( Δ t ) - & \\ ( {\sum }_{{s}_{i} ∈ {c}_{j}} {r}_{i} ) + ( Δ {d}_{j} - Δ d ) {c}_{g} & otherwise\end{matrix}$$

Q={q₁, q₂, . . . , qₙ} can hold the target quantity for each item a buyer needs, P={pⱼ₁, pⱼ₂, . . . , pⱼₙ} can keep the corresponding bids from the sellers in cⱼ. Total cost, as determined by combinatorial procurement component 410 can then be determined as:

TC_{c}_{ⱼ}=PC_{c}_{ⱼ}+Σₛ_{ᵢ}_{∈c}_{ⱼ}pⱼᵢqᵢ

There can be sellers in the market that can supply a bundle of products. These sellers can take special advantage of the claimed subject matter as they require fewer numbers of stops, thus less potential divergence from a pre-established path, and concomitantly lower costs of personal inconvenience.

TC(c_{bundle})=PC_{bundle}+p_{bundle}Q

Combinatorial procurement component 410 can thereafter apply to VCG mechanism to determine the payment each seller receives. The VCG mechanism is a generalized version of the Vickrey auctions applied to combinatorial settings, an approach that a strategy-proof and efficient. c* can represent the combination of sellers that satisfy the buyer's combinatorial demands with minimal total cost, c*₋ᵢcan denote the best allocation possible excluding seller sᵢ from the auction. Payment tᵢ for sᵢ ∈ c* bidding pᵢ on quantity qᵢ can thus be determined by combinatorial procurement component 410 as,

$$\begin{matrix}{c}^{*} = {arg min}_{{c}_{i} ∈ C} {TC}_{{c}_{j}} \\ {t}_{i} = {TC}_{{c}_{- i}^{*}} - {TC}_{{c}^{*}} + {p}_{i} {q}_{i} \\ {c}_{- i}^{*} = {arg min}_{{c}_{j} ∈ C , {s}_{i} ∉ {c}_{j}} {TC}_{{c}_{j}}\end{matrix}$$

Finding the optimal allocation in combinatorial auctions is known to be NP-hard. In mobile opportunistic commerce settings, the buyer typically has limited time to spend for personal procurement on a single trip. Therefore, the number of products that the buyer is interested in purchasing during a single trip is typically bounded by a small number. Given that the buyer is interested in n bytes in bundles and that the system has a maximum m members selling each product, the search space of the combinatorial auction is n!mⁿ. With the assumption that n is bounded by a small constant, the search space is polynomial in m.

To provide further context for the foregoing commentary regarding combinatorial procurement component 410, the following scenario is provided in which a buyer needs to by both groceries and gasoline during a single trip. Auction component 106 identifies three feasible gas stations, S₁, S₂, and S₃, and three feasible grocery stores, G₁, G₂, and G₃, and forms nine possible combinations. For each of the combinations, auction component 106, and more particularly, combinatorial procurement component 410, can construct personal cost functions and can combine these personal cost functions with seller bids to determine the total costs. Gas station S₁ and grocery store G₃, for the purposes of this illustration, offers the lowest total cost.

| | | Grocery | | |
|---|---|---|---|---|
| Combination | Gas Price | Price | PC | TC |
| S₁&G₁ | 30 | 13 | 8.5 | 51.5 |
| S₁&G₂ | 30 | 17 | 6.9 | 53.9 |
| S₁&G₃ | 30 | 10 | 6.8 | 46.8 |
| S₂&G₁ | 32 | 13 | 9.8 | 54.8 |
| S₂&G₂ | 32 | 17 | 9.5 | 58.5 |
| S₂&G₃ | 32 | 10 | 7.2 | 49.2 |
| S₃&G₁ | 33 | 13 | 8.8 | 54.8 |
| S₃&G₂ | 33 | 17 | 7.4 | 57.4 |
| S₃&G₃ | 33 | 10 | 8.8 | 51.8 |

Payment to the winner seller can be determined by combinatorial procurement component 410 as,

$${t}_{{S}_{1}} = {TC}_{{c}_{- {S}_{1}}^{*}} - {b}_{{G}_{2}} - {PC}_{{S}_{1} \& {G}_{2}} = 32.4$$

$${t}_{{G}_{2}} = {TC}_{{c}_{- {G}_{2}}^{*}} - {b}_{{S}_{1}} - {PC}_{{S}_{1} \& {G}_{2}} = 14.7$$

A seller, s_{bundle}, supplying both gas and grocery enters the market offering $ 5.7 personal cost and $ 44.6 total cost and becomes the new winner. Payment to s_{bundle} can be calculated by combinatorial procurement component 410 as follows:

$$\begin{matrix}{t}_{bundle} = TC ( {c}_{- bundle}^{*} ) - PC ( bundle ) \\ = 46.8 - 4.7 \\ = 42.1\end{matrix}$$

Multi-attribute auctions allow sellers to compete not only in the price dimension but also on the attributes of a product. Accordingly, the matter disclosed and claimed herein can provide mechanisms to construct and utilize ontologies of products in the market, to allow buyers to evaluate brands and attributes of products, and to allow sellers enter individual bidding functions for product brands and types. In order to facilitate the foregoing, multi-attribute procurement component 412 can utilize Vickrey auction determinations adjusted to the multi-attribute personal procurement setting. Auction rules and mechanisms in a multi-attribute setting can be complicated as auction component 106 aims to find a seller, the brand, and the type of the product that offers the highest value to the buyer.

Auction component 106, and in particular multi-attribute procurement component 412, can develop an ontology for products available in the market. This ontology can be utilized to identify brands and attributes to be considered in preference elicitation, bid collection, and winner determination. Multi-attribute procurement component 412, without limitation, can create a hierarchical tree structure for each product X. As will be understood by those moderately skilled in this field of endeavor, other applicable structures can be employed to achieve the same purpose, and as such employment of these structures will fall within the ambit and purview of the claimed matter.

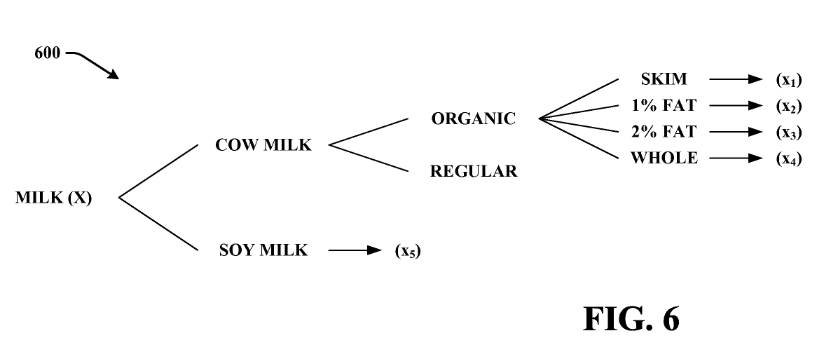

Every leaf in the tree structure, xᵢ, can be a product type that is a distinct combination of attributes of the product. As such, product X can be expressed as X={x₁, x₂, . . . , xₙ} and can denote the types of product the buyer can select from. Additionally, a product type can be defined by the tuple xᵢ=Yₓ_{ᵢ},Aₛ_{ᵢ}} where Yₓ_{ᵢ} represents a set of brands for that product type and Aₓ_{ᵢ} denotes a set of attributes defining xᵢ. Aₓ_{ᵢ} is the set of nodes that are traversed from the root of the product tree to get to xᵢ. FIG. 6 provides depiction of an illustrative product ontology in relation to milk products and or milk substitutes.

A_{X}=∪ₓ_{ₓ}_{∈X}Aₓ_{ᵢ} defines the set of all attributes for product X, and Y_{X}=∪ₓ_{_{y}}_{∈X}Yₓ_{ᵢ} the set of all brands offering X. Buyer preference agent 204 can be modified to provide buyer utility values for every element of A_{X} and Y_{X}. These values can represent how much the buyer is willing to pay to have a product with that brand or that attribute. The seller proxies provide bidding functions in the form of bₛ_{ᵢ}(xᵢ,yₓ_{ᵢ}), for brand yₓ_{ᵢ} of product type xᵢ.

The valuation of a buyer for product type xᵢ of brand y can be modeled with an additive utility function where it is assumed that all attributes are known by the system and the attributes are independent. Thus, if U_{A} and U_{B} are utility functions utilized by multi-attribute procurement component 412 for attributes and brands respectively, the buyer valuation of product type xᵢ of brand yₓ_{ᵢ}, U(xᵢ,yₓ_{ᵢ}) can be determined by multi-attribute procurement component 412 as,

$$U ( {x}_{i} , {y}_{{x}_{i}} ) = {U}_{B} ( {y}_{{x}_{i}} ) + {\sum }_{{a}_{k} ∈ {A}_{{x}_{i}}} {U}_{A} ( {a}_{k} )$$

The value of a seller sⱼ and product X, V(sⱼ,X), can be the maximum value obtained by the seller for any {xᵢ, yₓ_{ᵢ}} combination. {x*ₛ_{ⱼ},y*ₛ_{ⱼ}} is the highest valued product type and brand combination offered by sⱼ.

$$V ( {s}_{j} , X ) = {max}_{{x}_{i} ∈ X , {y}_{{x}_{i}} ∈ {Y}_{{x}_{i}}} \{ U ( {x}_{i} , {y}_{{x}_{i}} ) - {b}_{{s}_{j}} ( {x}_{i} , {y}_{{x}_{i}} ) \} - {PC}_{{s}_{j}}$$

$$\{ {x}_{{s}_{j}}^{*} , {y}_{{s}_{j}}^{*} \} = {max}_{{x}_{i} ∈ X , {y}_{{x}_{i}} ∈ {Y}_{{x}_{i}}} \{ U ( {x}_{i} , {y}_{{x}_{i}} ) - {b}_{{s}_{j}} ( {x}_{i} , {y}_{{x}_{i}} ) \} - {PC}_{{s}_{j}}$$

The winner of the auction, w₁, is typically the seller offering the highest value. Since, multi-attribute procurement component 412 typically implements a Vickrey Auction, the payment, t_{w}_{₁}, can depend on the value of the seller would the second highest value, w₂.

$${w}_{1} = arg {max}_{{s}_{j}} \{ V ( {s}_{j} ) \}$$

$${t}_{{w}_{1}} = U ( {x}_{{w}_{1}}^{*} , {y}_{{w}_{1}}^{*} ) - V ( {w}_{2} ) - {PC}_{{w}_{1}}$$

t_{w}_{₁} can depend on the buyer's evaluation, winner's personal cost, and w₂'s bidding function, and is therefore independent of w₁'s bidding. The dominant strategy of the sellers is to bid truthfully and the general properties of Vickrey auctions are preserved a multi-attribute settings. The multi-attribute personal procurement setting is more challenging for both sellers and buyers. In this setting, the buyer is requested to give a value for every attribute of products; similarly, sellers provide bidding functions for every combination of product type and brand. These tasks are obviously difficult for all players.

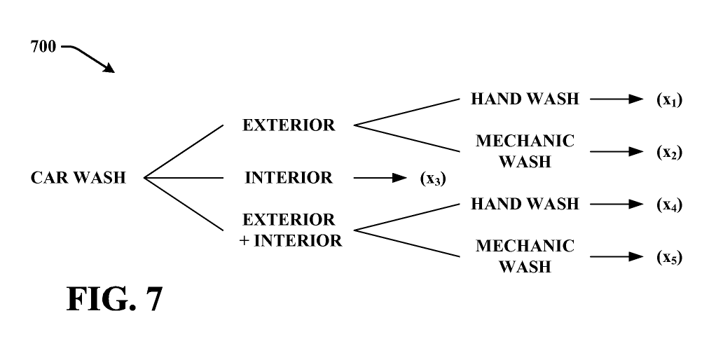

To provide perspective for the foregoing functionality of multi-attribute procurement component 412, the following illustrative multi-attribute auction for purchasing a car wash example is presented. Multi-attribute procurement component 412 can generate and employ an ontology for car wash services as exemplified in FIG. 7. In this instance, buyers can enter preferences for every car wash attribute.

| | Buyer Preferences in $ |
|---|---|
| Exterior | 5 |
| Interior | 3 |
| Exterior and Interior | 8 |
| Hand Wash | 2 |
| Mechanic Wash | 0 |

Multi-attribute procurement component 412 finds three feasible sellers and requests that each seller send their bids for each xᵢ. For each seller, multi-attribute procurement component 412 can estimate the buyer's inconvenience cost

| | bₓ₁ | bₓ₂ | bₓ₃ | bₓ₄ | bₓ₅ | PC |
|---|---|---|---|---|---|---|
| Seller 1 | 4 | 3 | 2 | 5 | 4 | 1 |
| Seller 2 | 5 | 3 | 2 | 6 | 4 | 2 |
| Seller 3 | 6 | 4 | 3 | 9 | 5 | 2 |

Multi-attribute procurement component 412 can determine the utility to the buyer for every xᵢ and the value of each seller to the buyer.

| U(x₁) | U(x₂) | U(x₃) | U(x₄) | U(x₅) |
|---|---|---|---|---|
| 7 | 5 | 3 | 10 | 8 |

V(Seller1)=max{3,2,1,5,4}−1=4,x_{Seller1}*={x₄}

V(Seller2)=max{2,2,1,4,4}−2=2,x_{Seller2}*={x₄,x₅}

V(Seller3)=max{1,1,0,1,3}−2=1,x_{Seller3}*={x₅}

Multi-attribute procurement component 412 can then select x₄ to purchase and Seller 1 as the winner of the auction. Multi-attribute procurement component 412 can determine payment as,

t_{Seller1}=U(x₄)−V(Seller2)−PC_{Seller1}=7

As will be comprehended by those conversant in this field of endeavor, the ultimate goal of the matter as claimed and disclosed is finding the optimal opportunistic plan that offers the highest combined value to the mobile user. The previous components set forth and discussed above have achieved this goal through a myopic approach, focusing on the current trip of the buyer. However, typically an optimal decision can generally only be achieved by considering future opportunities and comparing the estimated future values with the value of acquiring the item, service or experience now. Non-myopic decision component 414 therefore utilizes an opportunistic plan to the current trip if its current value estimation is higher than future predictions.

An auction can be defined by the triplet (S, PC, b) where S represents the set of feasible sellers, PC indicates the vector of buyers personal costs for each seller in S, and b represents the bid vector of the sellers. One can think of non-myopic decision component 414 as being an oracle that produces the value of a given auction by considering the current set of feasible sellers, current personal costs of the buyer, and current bids of the feasible sellers. Similarly, non-myopic decision component 414 can be utilized to predict the value of future auctions without violating the privacy-preserving, objectiveness and trust properties of auction component 106 as future values are not revealed to the seller but only used by non-myopic decision component 414 to make the decision of whether to postpone an opportunistic plan.

Non-myopic decision component 414 through utilization of a buyer's calendar, for example, can construct a list of future trips (F) that are future opportunities to engage in a transaction. The elements of F can be determined with an item specific heuristic. For example, when purchasing gasoline, if the maximum distance that can be traveled before gas purchase is dₘₐₓ and the distance to be traveled for each individual trip (fᵢ) is dᵢ; F is the largest set of individual trips (fᵢ) that satisfies Σ_{f}_{ᵢ}_{∈F}dᵢ≦dₘₐₓ.

For each future trip fᵢ, the set of feasible sellers S can be determined using a seller database associated with auction component 106, for example. Non-myopic decision component 414 can also predict the personal costs of vector of the buyer for trip i. Personal cost of the buyer for seller i can be determined by the time function (T), travel duration with a stop at seller i, Δtᵢ, the extra distance to be traveled for seller i, Δdᵢ, and the rating of seller i, (rᵢ). Δtᵢ and Δdᵢ can be obtained from a map and traffic prediction service associated with auction component 106, rᵢ can be located within a buyer database also affiliated with auction component 106. Time function of the buyer for the trip tᵢ can be constructed by non-myopic decision component 414 can be constructed as follows, given that t_{f}^{d}is the start time of the next deadline, tₚ^{d} is the end time of the previous deadline, t_{off} is the time it takes to start the trip, cⁿ is the minute cost before a deadline, and c^{d} is the minute cost after the deadline (m=t_{f}^{d}−tₚ^{d}−t_{off}).

$$T ( t ) = \{ \begin{matrix}{tc}^{n} & t < m \\ m {c}^{n} + ( t - m ) {c}^{d} & otherwise\end{matrix}$$

Assuming that prices do not fluctuate until trip fᵢ, non-myopic decision component 414 can utilize the current bid vector of the set of feasible sellers of trip fᵢto predict the value (V*ᵢ) of having the auction during fᵢ. V*ᵢ can be multiplied with a discounting factor α(i) to estimate the real value of auction at trip fᵢ. Thus, non-myopic decision component 414 can compute V_{future} as,

V_{future}=maxᵢ{α(i)V*(i)}

Non-myopic decision component 414 can use V_{future} to decide whether to notify the buyer about the new opportunistic plan. For instance, if V_{future}>V*, non-myopic decision component 414 can postpone the opportunistic plan to future trips, otherwise the current trip of the buyer is updated with a stop offering V*.

The discounting factor adjusts the value of future trips so that the following factors can be taken into consideration: (1) non-myopic decision component 414 can be uncertain about a buyer's future plans; (2) buyer's future plans can change; (3) the goals of the buyer can change, and the current opportunistic plan may not be valid in the future (e.g., the amount of gas in the car may run out unexpectedly); and (4) prices can fluctuate and the prices may get higher on future trips. The discounting factor represents the systems uncertainty about the future. The uncertainty increases that any future step, therefore non-myopic decision component 414 can select discounting factors (α) that satisfy α(i)>α(i+1), that is to say they get smaller at every future step. Utilizing non-myopic decision making can be advantageous in many ways. By considering the future opportunities, the system is improved finding better deals for the buyer and therefore maximizing the value that the system offers to the buyer. With future look ahead, buyers are not forced to make decisions on the current trip. If the cognitive load or the time cost of the buyer is very high, the system can decide to postpone the opportunistic plan and not to interrupt the buyer. Consequently, non-myopic decision making as effectuated by non-myopic decision component 414 aids in the management of the cognitive load of the buyer while driving. Non-myopic decision making prevents and discourages the occurrence of monopolies and the creation of more efficient market places. Sellers that are left alone in a region can ask for high prices as they turn into monopolies without any competition. The claimed matter, and more properly non-myopic decision component 414 can foresee the higher prices in monopoly regions and can advise buyers to make purchases before going into these areas. In the long run, monopolies with falling sales will ultimately have to reduce their prices to those prevalent in the market place to regain their customer base.

The goal of the claimed subject matter is to opportunistically find the best deals available for the buyer, updating current plans and to notify the buyer. Nevertheless, the matter as claimed can find itself subject to uncertainties about the buyer's current state, preferences, and willingness to update current plans. Sometimes it can be beneficial to include the buyer in the decision making process. Thus, the subject matter as claimed provides mixed initiative procurement component 416 that can utilized a number of methods to solicit buyers for feedback when necessary to resolve buyer uncertainty and issues that can arise when agents or proxies have the power to make commitments on behalf of sellers and buyers.

Mixed initiative procurement component 416 can make use of probabilistic user models to predict the current state of the buyer, and therefore determine the personal cost to the buyer for different sellers in the region. The outcome of an auction can therefore be affected by the current state of the buyer. If the buyer is predicted to be very busy, his or her time cost can be estimated to be high, therefore, mixed initiative procurement component 416 can favor sellers that are in close proximity. Conversely, if the time cost of the buyer is low, a more distant seller with lower prices can be selected as the winner of the auction. However, probabilistic buyer models can have uncertainties and may not correctly estimate the state of the buyer, and thus may fail to deliver the best available deal to the buyer. Accordingly, the value of auction component 106 can be improved if the current state of the buyer is employed for decision-making rather than a model estimate. On the other hand, interrupting the buyer merely to obtain feedback can disturb him or her and negatively affect his or her attention level and performance. Consequently, the overall goal of mixed initiative procurement component 416 is to determine whether it is beneficial to solicit feedback from the buyer about his or her state to resolve uncertainties.

Mixed initiative procurement component 416 can, for instance, utilize two probabilistic models to evaluate the current state of the buyer and construct a time cost function T: an attendance model to predict the buyer's probability of attending the next deadline p(A), a priority model that predicts the probability of the next deadline being high priority p(H), medium priority p(M), and/or low priority p(L). Mixed initiative procurement component 416 can also request the buyer to define per minute cost values before a deadline cⁿ, after missing a high priority deadline c^{H}, medium priority deadline c^{M}, and/or low priority deadline c^{L}. Mixed initiative procurement component 416 can thereafter construct or develop time cost models for the possible states that the buyer can be in: T [symbol] ^{A} for not attending the next deadline; T_{H}^{A}, T_{M}^{A}, T_{L}^{A} for attending the next deadline that is high, medium, low priority respectively (d represents the time to the next deadline).

$${T}^{- A} ( t ) = {tc}^{n}$$

$${T}_{H}^{A} ( t ) = \{ \begin{matrix}{tc}^{n} & t < d \\ d {c}^{n} + ( t - d ) {c}_{H}^{d} & otherwise\end{matrix} \\ {T}_{M}^{A} ( t ) = \{ \begin{matrix}{tc}^{n} & t < d \\ d {c}^{n} + ( t - d ) {c}_{M}^{d} & otherwise\end{matrix} \\ {T}_{L}^{A} ( t ) = \{ \begin{matrix}{tc}^{n} & t < d \\ d {c}^{n} + ( t - d ) {c}_{L}^{d} & otherwise\end{matrix}$$

If mixed initiative procurement component 416 does not receive feedback from the buyer about the current state, it can use attendance and priority models to construct a time cost function (T [symbol] _{Ask}). It should be noted that T [symbol] _{Ask} can be based on predictions and therefore it may occasionally provide erroneous estimates of the time cost function of the buyer.

T [symbol] _{Ask}(t)=p(A)(p(H)T_{H}^{A}(t)+p(M)T_{M}^{A}(t)+(p(L)T_{L}^{A}(t))+(1−p(A))T [symbol] ^{A}

Without buyer feedback, mixed initiative procurement component 416 uses the T [symbol] _{Ask} function to determine the value of the auction (V [symbol] _{Ask}*)

V* [symbol] _{Ask}=V*(T [symbol] _{Ask})

When mixed initiative procurement component 416 receives the correct state of the buyer, it can utilize this state to construct a time cost function and thereafter evaluate the auction. Mixed initiative procurement component 416 determines the value of the auction for all possible states that a buyer can be in and weights these states with the buyer's likelihood to be in these states to estimate the value of the auction (V*_{Ask}) when buyer uncertainty is resolved.

V*_{Ask}=p(A)(p(H)V*(T_{H}^{A})+p(M)V*(T_{M}^{A})+p(L)V*(T_{L}^{A}))+(1−p(A))V*(T^{≠A})

The benefit of resolving the uncertainty of the buyer model is the difference of the estimated outcome of the auction with and without asking about the feedback. The value of asking is the difference of the benefit of asking with the Expected Cost of Interruption (ECI), and is captured in the Expected Value of Asking (EVA) value. EVA determination is shown below. Mixed initiative procurement component 416 asks for buyer feedback if EVA is estimated to be positive.

EVA=V*_{Ask}−V* [symbol] _{Ask}−ECI

Auction component 106 can be responsible for matching the buyer with the best available provider (seller) in the region and notifies the buyer about the opportunity. Nevertheless, auction component 106 can be dependent on the buyer to follow the updated plans. Thus, mixed initiative procurement component 416 needs to be able to validate auction results to give the buyer control over his or her plans but nevertheless agree with the determined match and/or suggested opportunity to protect the privacy of sellers.

The privacy of the sellers can be threatened if the result and the value of the auction are revealed without payment. Accordingly, auction component 106 may need to commit to the transaction before revealing the auction value to the buyer, for otherwise buyers can explore the market to find other sellers and thus violate privacy of identified sellers. Nevertheless, if the buyer rejects to follow the developed course of action, he or she can be forced to pay a cancellation fee, for instance. In order to avoid destroying the privacy of sellers to the transaction, mixed initiative procurement component 416 can communicate with the buyer to validate the results of the auction so that the privacy of the sellers is respected. Mixed initiative procurement component 416 can for example, ask the buyer to commit to the current auction without revealing the final value or the winner of the auction, and/or mixed initiative procurement component 416 can commit to the auction without asking the buyer and the buyer can thereafter cancel the transaction after being notified about the auction result by paying a cancellation fee.

In order to decide when it is more beneficial to ask the buyer to commit rather than automatically committing to the auction result on its own volition, mixed initiative procurement component 416 can employ the following formulation. The benefit of giving the buyer the value of the auction is to allow him or her to make a better informed decision. The probability of the buyer accepting a deal is higher if the value of the auction is high. Accordingly, a model of the likelihood of the buyer accepting the deal with respect to the value of that deal can be constructed. Such a model can be predictive of the acceptance probability for a deal. Mixed initiative procurement component 416 can store previous buyer behavior as pairs of auction value and buyer response (V*, {Yes, No}). Using this data, mixed initiative procurement component 416 can construct a predictor function P_{Accept}(V) that provides the probability of a buyer accepting a deal of value V.

When the buyer does not know the value of the auction, the probability of accepting (P_{Accept} [symbol] ^{V}) can be estimated by looking at general behavior; P_{Accept} [symbol] ^{V}=(Number of Accepted Deals)/(Total Number of Deals). The benefit of notifying the buyer about the value of the deal (VOV*) can be determined as below given that V*_{V}, V* [symbol] _{V} is the estimated value to the buyer if notified and if not notified about the value of the auction, V*_{now} is the value of the current auction, V*_{future} is the estimated value of future auctions for the same product or service:

VOV*=V*_{V}−V* [symbol] _{V}

V*_{V}=P_{Accept}(V*_{now})V*_{now}+(1−P_{Accept}(V*_{now}))V*_{future}

V* [symbol] _{V}=P_{Accept} [symbol] ^{V*}_{now}+(1=P_{Accept} [symbol] ^{V})V*_{future}

VOV*=(P_{Accept}(V*_{now})−P_{Accept} [symbol] ^{V})(V*_{now}−V*_{future})

If the value of the auction is given to the buyer, mixed initiative procurement component 416 must commit to the auction before the buyer makes his or her decision and therefore can be faced with a cost of commitment (COC):

COC=(1−P_{Accept}(V*_{now}))f_{cancel}

where f_{cancel} represents a cancellation fee attributable to voiding the transaction. It is therefore beneficial for mixed initiative procurement component 416 to commit first and notify the buyer later, if VOV* is higher than the cost of commitment, otherwise mixed initiative procurement component 416 can ask the buyer whether to commit without revealing the auction value.

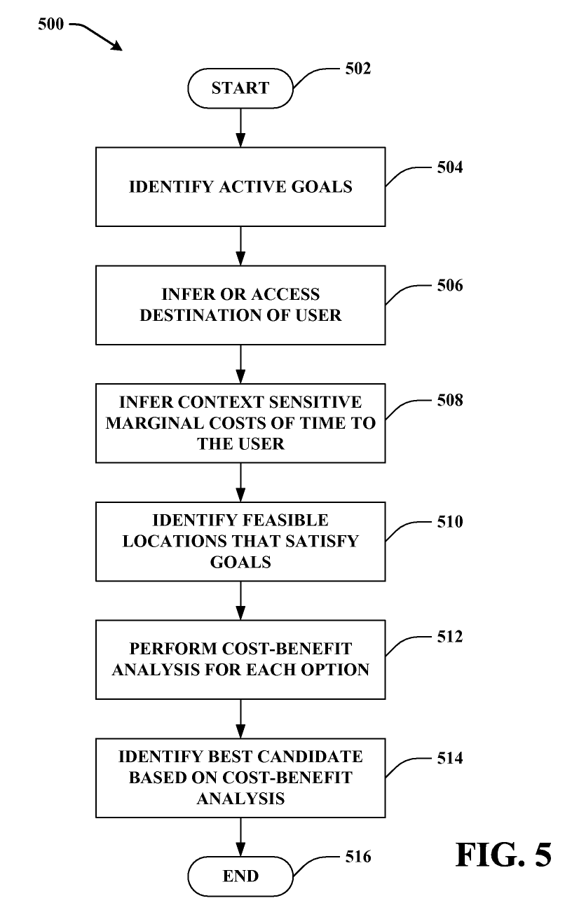

In view of the illustrative systems shown and described supra, methodologies that may be implemented in accordance with the disclosed subject matter will be better appreciated with reference to the flow chart of FIG. 5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 5 illustrates a flow diagram of a machine implemented methodology 500 that effectuates and facilitates mobile opportunistic commerce in accordance with an aspect of the claimed subject matter. Methodology 500 can commence at 502 where various initializations tasks can be performed after which the method can proceed to 504. At 504 active goals can be identified, accessed, or acquired. At 506 buyer or user destinations can be inferred or accessed. At 508 context-sensitive marginal costs of time associated with the buyer or user can be determined. At 510 a geospatial search for feasible sellers within a region or location that satisfies the buyer or user's active goals can be undertaken. At 512 a cost-benefit analysis can be performed with respect to each identified feasible seller and at 514 the best candidate based at least in part on the cost-benefit analysis can be determined. At 516 the methodology can terminate.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data strictures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the constriction of new events or actions from a set of observed events and/or stored event data, whether or not the events are correlated in close temporal proximity, and whether the events and data come from one or several event and data sources. Various classification schemes and/or systems (e.g., support vector machines, Bayesian belief networks and other probabilistic graphical models, association rules, logical inference, etc.) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

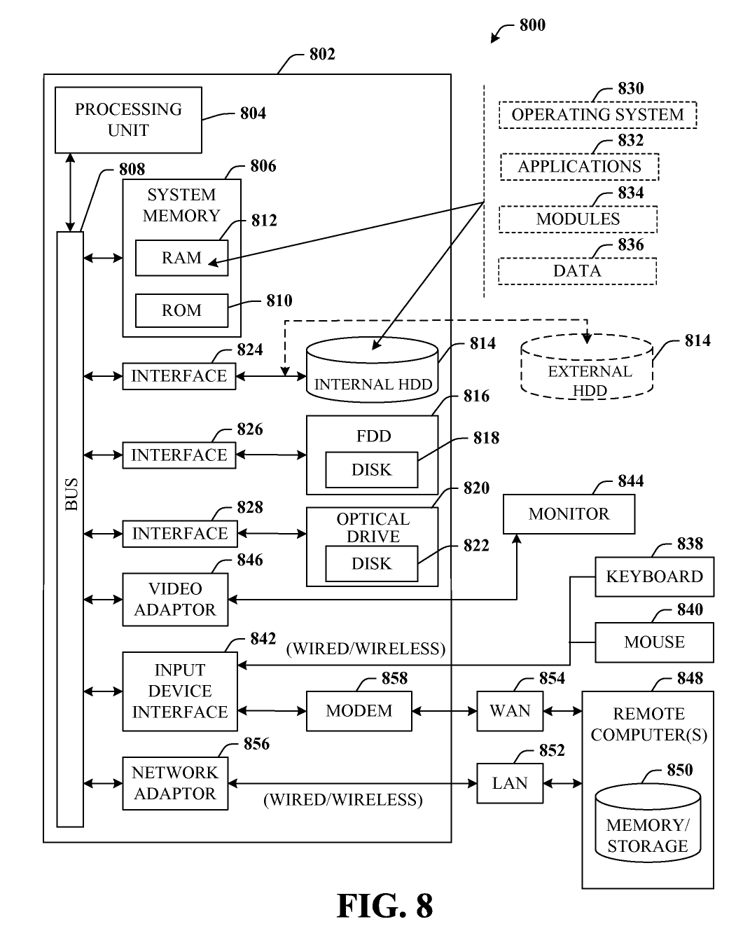

Referring now to FIG. 8, there is illustrated a block diagram of a computer operable to execute the disclosed system. In order to provide additional context for various aspects thereof, FIG. 8 and the following discussion are intended to provide a brief, general description of a suitable computing environment 800 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the illustrative environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 894 interface technologies. Other external drive connection technologies are within contemplation of the claimed subject matter.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 812, including an operating system 830, one or more application programs 832, other program modules 834 and program data 836. All or portions of the operating system, applications, modules, and/or data can also be cached in the RAM 812. It is to be appreciated that the claimed subject matter can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 894 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are illustrative and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a Callback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

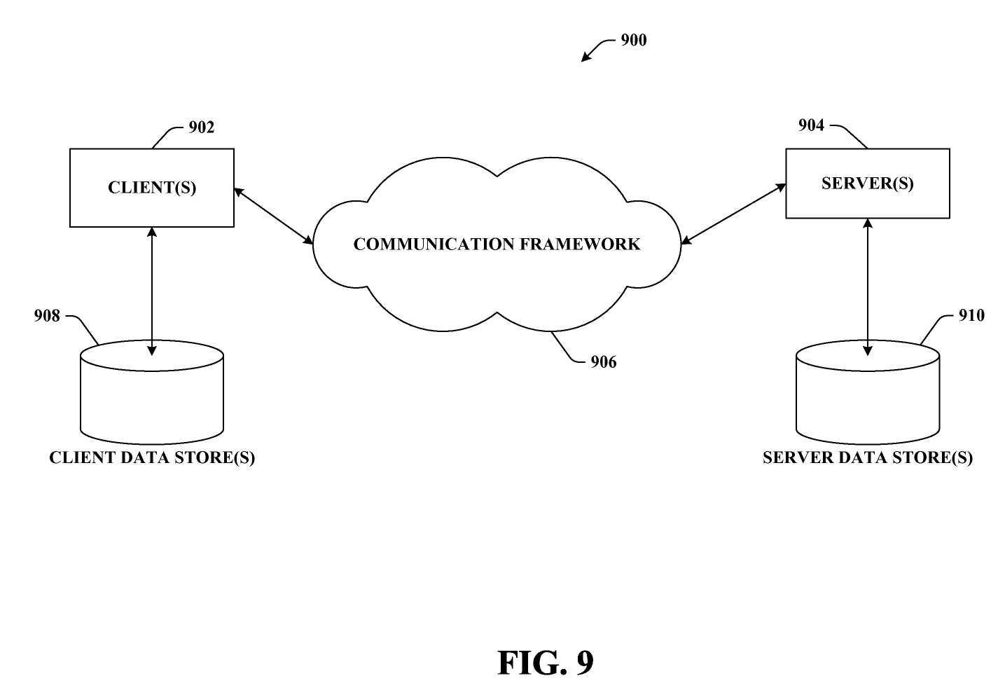

Referring now to FIG. 9, there is illustrated a schematic block diagram of an illustrative computing environment 900 for processing the disclosed architecture in accordance with another aspect. The system 900 includes one or more client(s) 902. The client(s) 902 can be hardware and/or software (e.g., threads, processes, computing devices). The client(s) 902 can house cookie(s) and/or associated contextual information by employing the claimed subject matter, for example.

The system 900 also includes one or more server(s) 904. The server(s) 904 can also be hardware and/or software (e.g., threads, processes, computing devices). The servers 904 can house threads to perform transformations by employing the claimed subject matter, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system implemented on a machine that effectuates and facilitates mobile opportunistic commerce, comprising:
a component that receives at least one of a buyer's primary destination or a buyer's purchasing preferences via an interface, the component performs a geo-spatial search to identify a feasible seller in close proximity to a prescribed route to the buyer's primary destination, the component notifies the feasible seller to submit a bidding function that satisfies the buyer's purchasing preferences and constructs a value function for the feasible seller based at least in part on the bidding function that satisfies the buyer's purchasing preferences, a proximity of the feasible seller to the prescribed route, or a time cost associated with deviating from the prescribed route, the component determines a winning seller through application of auction rules or utilization of the value function, notifies the buyer of the winning seller, and updates the prescribed route to the buyers primary destination to include directions to the winning seller.

2. The system of claim 1, the feasible seller submits the bidding function without notice of a buyer's identity or the buyer's purchasing preferences.

3. The system of claim 1, the feasible seller's bidding function concealed from the buyer.

4. The system of claim 1, the component implements a fee structure to discourage a buyer from exploring a bidding price of the feasible seller.

5. The system of claim 1, the component implements a second-price sealed bid auction where a final payment price between the buyer and the winning seller is determined as a summation of a second lowest bid provided by a seller and a personal cost associated with the buyer.

6. The system of claim 1, the component utilizes feedback from the buyer to rate the winning seller, the feedback utilized to determine future winning sellers.

7. The system of claim 1, the component predicts a current state of the buyer based at least in part on a probabilistic model, the current state of the buyer utilized by the component to ascertain whether to solicit feedback from the buyer regarding a pending commitment associated with a transaction that satisfies the buyer's purchasing preferences.

8. A machine implemented method that effectuates mobile opportunistic commerce, comprising:
obtaining a buyer's destination or buyer's product or service requirements;
identifying a seller capable of fulfilling the buyer's product or service requirements;
soliciting bids from the seller;
generating a value function for the seller based at least in part on the bid;
determining a successful seller based on a comparison of the value function with value functions associated with one or more unsuccessful sellers:
notifying the buyer of the successful seller and providing to the buyer an analysis of the value function associated with the successful seller; and
updating a route to the buyer's destination based at least in part on a location of the successful seller.

9. The method of claim 8, the identifying further comprises utilizing a geo-spatial search to locate a seller proximate to the route to the buyer's destination.

10. The method of claim 9, the proximity of the seller to the route to the buyer's destination limited by a buyer's time-cost function.

11. The method of claim 8, the bids from the seller associated with products or services that satisfy in part the buyer's product or service requirements.

12. The method of claim 8, further comprising generating and utilizing a product or service ontology, the product or service ontology employed to identify corresponding products or services that satisfy the buyer's product or service requirements.

13. The method of claim 8, the determining further comprising utilizing a buyer's time-cost function to ascertain a maximum permissible deviation from the route.

14. The method of claim 8, the bids solicited from the seller without the seller knowing the buyer's destination or buyer's product or service requirements.

15. The method of claim 8, the determining further comprising implementing a second-price sealed bid auction where a final payment price between the buyer and the successful seller is deduced as a second lowest bid obtained from a plurality of member sellers.

16. The method of claim 8, further comprising automatically establishing a strike price between the buyer and successful seller based at least in part on a probabilistically determined buyer state.

17. A system that effectuates mobile opportunistic commerce, comprising:
means for identifying a seller capable of fulfilling a buyer's product or service requirements;
means for generating a value function for the seller based at least in part on received bids from the seller;
means for comparing the value function for a first seller with a value function associated with one or more second seller, based at least in part on the comparison determining a successful seller;
means for notifying the buyer of the successful seller; and
means for modifying a route to a buyer's destination based a location of the successful seller.

18. The system of claim 17, the value function includes an inconvenience cost associated with the buyer.

19. The system of claim 17, further comprises means for interrogating the buyer's calendar and utilizing entries included in the buyer's calendar to constrict a list of future opportunities to engage in a transaction to satisfy the buyer's product or service requirements.

20. The system of claim 17, further comprises means for ascertaining a buyer's current state, the buyer's current state utilized by the means for identifying the seller to commit the buyer to a transaction between the successful seller and the buyer at a mutually agreeable strike price.
